(19) United States
(12) Patent Application Publication
(10) Pub. No.: US 2021/0173892 A1
(43) Pub. Date: Jun. 10, 2021

(54) Factorization of Integers without the use of Division or Knowledge of Integer Prime Values

(71) Applicant: John Thomas Favor, Los Angeles, CA (US)

(72) Inventor: John Thomas Favor, Los Angeles, CA (US)

(21) Appl. No.: 16/706,715

(22) Filed: Dec. 7, 2019

(51) Int. Cl. G06F 17/10

(52) U.S. Cl. CPC G06F 17/10

(57) ABSTRACT

This method uses the operations of addition or subtraction in combination with comparison to determine a factor pair from a given odd integer.

### CROSS-REFERENCE TO RELATED APPLICATIONS

No cross referenced applications are relevant.

### FEDERALLY SPONSORED RESEARCH OR DEVELOPMENT

No Federally sponsored research or development is relevant.

### PARTIES TO A JOINT RESEARCH AGREEMENT

No joint research agreement is relevant.

### REFERENCE

No external references are needed.

A program listing is included with the specification.

### PRIOR DISCLOSURES BY THE INVENTOR OR A JOINT INVENTOR

No prior disclosures are relevant and I am the sole inventor.

### BACKGROUND OF THE INVENTION

This invention provides an alternative to using division and integer primes as a method of determining a factor pair when an odd integer is given.

### BRIEF SUMMARY OF THE INVENTION

Two integer sums are compared and selectively modified. If the sums match, a factor pair has been identified. Otherwise, the boundary condition is reached and the program terminates without a factor pair. A prime is recognized.

### BRIEF DESCRIPTION OF THE DRAWING VIEWS

No drawings are provided.

A program listing is given at the end of the specification.

### DETAILED DESCRIPTION OF THE INVENTION

Key Elements of a Code Implementation:

An unknown value G is added to a ‘small’ sum which begins with the value of zero.

The ‘large’ sum is calculated by determining the square root of G and then choosing the smallest integer square larger than that value.

The new idea here is that of increasing the sum values in a method that guarantees that the new sum value will be an integer square.

All the odd numbers are used in sequence in either ascending or descending order.

Because the Pythagorean Theorem guarantees that the difference of integer squares must be representable as a factor pair, the relation ‘large’ sum=G+‘small’ sum will deliver a factor pair when the equation is in balance.

This description began from the ‘bottom’ where the ‘small’ sum begins at zero.

It is also possible to start at the top and work down, decrementing the sums at each step instead.

This makes it possible to partition the collection of terms to be evaluated in many ways.

The result of this will be to speed up the factoring process and to find a factor pair in a specified amount of time.

These ideas in combination enable the determination of factor pairs from a given odd integer value. The complexity of addition, subtraction and comparison is recognizably less than what is needed to determine square roots. Division or knowledge of divisors is unnecessary. The example that follows is one of the simplest implementations. It is intended for use in an application such as the 64 bit version of Microsoft Excel. Other implementations in Microsoft C# and the Microsoft Quantum language have been created but are unnecessary here. A boundary value is determined according to the given number provided. If the boundary is reached, no factor pair has been found and the given number is a prime integer.

PROGRAM CODE:
Function findFactor(CellRef As String) As LongLong
′This code uses the 64 bit Excel data type LongLong
′32 bit code uses the Excel data type Long
Dim GH As LongLong, GL As LongLong, deltaGH_Sum As LongLong,
deltaGL_Sum As LongLong, add2GH As LongLong, add2GL As LongLong,
countGH As LongLong, countGL As LongLong, F1 As LongLong
Dim F2 As Double
Dim Zero As LongLong
′User provides code to deliver the composite number
′and associate it with ′the variable numberToBeFactored′
Dim numberToBeFactored As LongLong
numberToBeFactored = 91999
GH = (numberToBeFactored + 1) / 2
GL = (numberToBeFactored − 1) / 2
add2GH = numberToBeFactored − 2
add2GL = numberToBeFactored − 4
countGH = 1
countGL = 1
deltaGH_Sum = numberToBeFactored
deltaGL_Sum = numberToBeFactored − 2
F1 = 0
F2 = 0#
Zero = 0
While ((add2GH >= Zero) And (add2GL >= Zero))
If (deltaGH_Sum > deltaGL_Sum) Then
deltaGL_Sum = deltaGL_Sum + add2GL
add2GL = add2GL − 2
countGL = countGL + 1
End If
If (deltaGH_Sum < deltaGL_Sum) Then
deltaGH_Sum = deltaGH_Sum + add2GH
add2GH = add2GH − 2
countGH = countGH + 1
End If
If (deltaGH_Sum = deltaGL_Sum) Then
F1 = countGL - countGH + 1
F2 = (numberToBeFactored / F1)
Rem MsgBox ″F1: ″& F1 & vbNewLine _
rem & ″F2: ″& F2 & vbNewLine _
rem & ″G: ″ & numberToBeFactored
GoTo Success
End If
If ((add2GH = 1) Or (add2GL = 1)) Then
GoTo Fail
End If
Wend
Fail:
Rem MsgBox ″Non-Trivial Factors not found″ findFactor = 1
Success:
If (F1 > 1) Then
find Factor = F1
End If
′Console.WriteLine(″″)
End Function

1) The claim of this application is in the use of integer square differences to locate factor pairs and

2) The use of successive odd integer values as a way of forcing a sum to always land on a value that is an integer square.
